(19) United States
(12) Patent Application Publication
(10) Pub. No.: US 2022/0121568 A1
(43) Pub. Date: Apr. 21, 2022

(54) METHOD AND SYSTEM OF MANIPULATION AND REDUNDANCY REMOVAL FOR FLASH MEMORIES

(71) Applicant: ALIBABA GROUP HOLDING LIMITED, George Town (KY)

(72) Inventor: Shu Li, San Mateo, CA (US)

(21) Appl. No.: 17/075,191

(22) Filed: Oct. 20, 2020

(51) Int. Cl. G06F 12/0802; G06F 3/06

(52) U.S. Cl. CPC G06F 12/0802; G06F 3/0604; G06F 2212/60; G06F 3/0679; G06F 3/0652

(57) ABSTRACT

The present disclosure provides methods, systems, and non-transitory computer readable media for optimizing data storing. An exemplary system comprises: receiving a storing operation to store data in a flash memory, the flash memory comprising a plurality of blocks; storing the data in a cache region of the flash memory, the cache region comprises a first set of blocks from the plurality of blocks; processing the data stored in the cache region; and storing the processed data into a capacity region of the flash memory, the capacity region comprising a second set of blocks from the plurality of blocks that are different from the first set of blocks in the cache region.

### TECHNICAL FIELD

The present disclosure generally relates to storage drives, and more particularly, to methods, systems, and non-transitory computer readable media for optimizing data organization of a storage memory.

### BACKGROUND

All modern-day computers have some form of secondary storage for long-term storage of data. Traditionally, hard disk drives (“HDDs”) were used for this purpose, but computer systems and servers are increasingly turning to flash memories such as solid-state drives (“SSDs”) as their secondary storage units. SSDs implement management firmware that is operated by microprocessors inside the SSDs for functions, performance, and reliability. While offering significant advantages over HDDs, the management mechanism of SSDs experience difficulties in meeting more demanding requirements on drive performance and power.

### SUMMARY OF THE DISCLOSURE

Embodiments of the present disclosure provide a method. An exemplary method comprises: receiving a storing operation to store data in a flash memory, the flash memory comprising a plurality of blocks; storing the data in a cache region of the flash memory, the cache region comprises a first set of blocks from the plurality of blocks; processing the data stored in the cache region; and storing the processed data into a capacity region of the flash memory, the capacity region comprising a second set of blocks from the plurality of blocks that are different from the first set of blocks in the cache region.

Embodiments of the present disclosure further provide a system. An exemplary system comprises a flash memory configured to store data based on a storing operation, the flash memory comprising: a cache region comprising a first set of blocks and configured to store the data in response to receiving the storing operation, wherein the data stored in the cache region is processed, and a capacity region comprising a second set of blocks and configured to store the processed data from the cache region.

Embodiments of the present disclosure further provide a non-transitory computer readable medium that stores a set of instructions that is executable by at least one processor of a computer system to cause the computer system to perform a method, the method comprising: receiving a storing operation to store data in a flash memory, the flash memory comprising a plurality of blocks; storing the data in a cache region of the flash memory, the cache region comprises a first set of blocks from the plurality of blocks; processing the data stored in the cache region; and storing the processed data into a capacity region of the flash memory, the capacity region comprising a second set of blocks from the plurality of blocks that are different from the first set of blocks in the cache region.

### BRIEF DESCRIPTION OF THE DRAWINGS

FIG. 1 is an example schematic illustrating a basic layout of an SSD, according to some embodiments of the present disclosure.

FIG. 2 is an illustration of an exemplary internal NAND flash structure of an SSD, according to some embodiments of the present disclosure.

FIG. 3 is an illustration of an exemplary flash memory with additional over-provisioning, according to some embodiments of the present disclosure.

FIG. 4 is an illustration of an example flash memory architecture with a cache region, according to some embodiments of the present disclosure.

FIG. 5 is an illustration of an example utilization for NAND blocks, according to some embodiments of the present disclosure.

FIG. 6 is an illustration of an example data organization in flash memory, according to some embodiments of the present disclosure.

FIG. 7 is an illustration of an example cache organization for NAND blocks with rotations, according to some embodiments of the present disclosure.

FIG. 8 is an illustration of an example organization of data in a cache region and a written capacity region, according to some embodiments of the present disclosure.

FIG. 9 is an illustration of an example method for managing data in a flash memory with a cache region, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

Modern day computers are based on the Von Neuman architecture. As such, broadly speaking, the main components of a modern-day computer can be conceptualized as two components: something to process data, called a processing unit, and something to store data, called a primary storage unit. The processing unit (e.g., CPU) fetches instructions to be executed and data to be used from the primary storage unit (e.g., RAM), performs the requested calculations, and writes the data back to the primary storage unit. Thus, data is both fetched from and written to the primary storage unit, in some cases after every instruction cycle. This means that the speed at which the processing unit can read from and write to the primary storage unit can be important to system performance. Should the speed be insufficient, moving data back and form becomes a bottleneck on system performance. This bottleneck is called the Von Neumann bottleneck.

High speed and low latency are factors in choosing an appropriate technology to use in the primary storage unit. Modern day systems typically use DRAM. DRAM can transfer data at dozens of GB/s with latency of only a few nanoseconds. However, in maximizing speed and response time, there can be a tradeoff. DRAM has three drawbacks. DRAM has relatively low density in terms of amount of data stored, in both absolute and relative measures. DRAM has a much lower ratio of data per unit size than other storage technologies and would take up an unwieldy amount of space to meet current data storage needs. DRAM is also significantly more expensive than other storage media on a price per gigabyte basis. Finally, and most importantly, DRAM is volatile, which means it does not retain data if power is lost. Together, these three factors make DRAM not as suitable for long-term storage of data. These same limitations are shared by most other technologies that possess the speeds and latency needed for a primary storage device.

In addition to having a processing unit and a primary storage unit, modern-day computers also have a secondary storage unit. What differentiates primary and secondary storage is that the processing unit has direct access to data in the primary storage unit, but not necessarily the secondary storage unit. Rather, to access data in the secondary storage unit, the data from the second storage unit is first transferred to the primary storage unit. This forms a hierarchy of storage, where data is moved from the secondary storage unit (non-volatile, large capacity, high latency, low bandwidth) to the primary storage unit (volatile, small capacity, low latency, high bandwidth) to make the data available to process. The data is then transferred from the primary storage unit to the processor, perhaps several times, before the data is finally transferred back to the secondary storage unit. Thus, like the link between the processing unit and the primary storage unit, the speed and response time of the link between the primary storage unit and the secondary storage unit are also important factors to the overall system performance. Should its speed and responsiveness prove insufficient, moving data back and forth between the memory unit and secondary storage unit can also become a bottleneck on system performance.

Traditionally, the secondary storage unit in a computer system was HDD. HDDs are electromechanical devices, which store data by manipulating the magnetic field of small portions of a rapidly rotating disk composed of ferromagnetic material. But HDDs have several limitations that make them less favored in modern day systems. In particular, the transfer speeds of HDDs are largely stagnated. The transfer speed of an HDD is largely determined by the speed of the rotating disk, which begins to face physical limitations above a certain number of rotations per second (e.g., the rotating disk experiences mechanical failure and fragments). Having largely reached the current limits of angular velocity sustainable by the rotating disk, HDD speeds have mostly plateaued. However, CPU's processing speed did not face a similar limitation. As the amount of data accessed continued to increase, HDD speeds increasingly became a bottleneck on system performance. This led to the search for and eventually introduction of a new memory storage technology.

The storage technology ultimate chosen was flash memory or flash drives. A flash memory is composed of circuitry, principally logic gates composed of transistors. Since flash storage stores data via circuitry, flash storage is a solid-state storage technology, a category for storage technology that does not have (mechanically) moving components. A solid-state based device has advantages over electromechanical devices such as HDDs, because solid-state devices does not face the physical limitations or increased chances of failure typically imposed by using mechanical movements. Flash storage is faster, more reliable, and more resistant to physical shock. As its cost-per-gigabyte has fallen, flash storage has become increasingly prevalent, being the underlying technology of flash drives, SD cards, the non-volatile storage unit of smartphones and tablets, among others. And in the last decade, flash storage has become increasingly prominent in PCs and servers in the form of SSDs.

SSDs are, in common usage, secondary storage units based on flash technology. Technically referring to any secondary storage unit that does not involve mechanically moving components like HDDs, SSDs are made using flash technology. As such, SSDs do not face the mechanical limitations encountered by HDDs. SSDs have many of the same advantages over HDDs as flash storage such as having significantly higher speeds and much lower latencies. However, SSDs have several special characteristics that can lead to a degradation in system performance if not properly managed. In particular, SSDs must perform a process known as garbage collection before the SSD can overwrite any previously written data. The process of garbage collection can be resource intensive, degrading an SSD's performance.

The need to perform garbage collection is a limitation of the architecture of SSDs. As a basic overview, SSDs are made using floating gate transistors, strung together in strings. Strings are then laid next to each other to form two dimensional matrices of floating gate transistors, referred to as blocks. Running transverse across the strings of a block (so including a part of every string), is a page. Multiple blocks are then joined together to form a plane, and multiple planes are formed together to form a NAND die of the SSD, which is the part of the SSD that permanently stores data. Blocks and pages are typically conceptualized as the building blocks of an SSD, because pages are the smallest unit of data which can be written to and read from, while blocks are the smallest unit of data that can be erased.

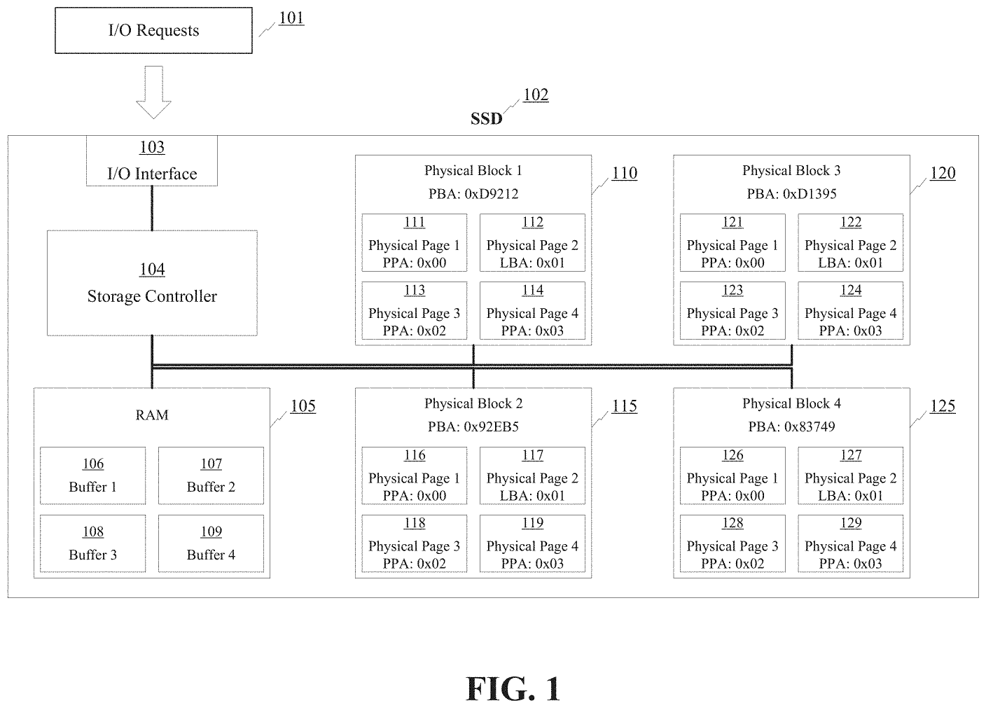

FIG. 1 is an example schematic illustrating a basic layout of an SSD, according to some embodiments of the present disclosure. As shown in FIG. 1, an SSD 102 comprises an I/O interface 103 through which the SSD communicates to a host system via input-output (“I/O”) requests 101. Connected to the I/O interface 103 is a storage controller 104, which includes processors that control the functionality of the SSD. Storage controller 104 is connected to RAM 105, which includes multiple buffers, shown in FIG. 1 as buffers 106, 107, 108, and 109. Storage controller 104 and RAM 105 are connected to physical blocks 110, 115, 120, and 125. Each of the physical blocks has a physical block address (“PBA”), which uniquely identifies the physical block. Each of the physical blocks includes physical pages. For example, physical block 110 includes physical pages 111, 112, 113, and 114. Each page also has its own physical page address (“PPA”), which is unique within its block. Together, the physical block address along with the physical page address uniquely identifies a page—analogous to combining a 7-digit phone number with its area code. Omitted from FIG. 1 are planes of blocks. In an actual SSD, a storage controller is connected not to physical blocks, but to planes, each of which is composed of physical blocks. For example, physical blocks 110, 120, 115, and 125 can be on a sample plane, which is connected to storage controller 104.

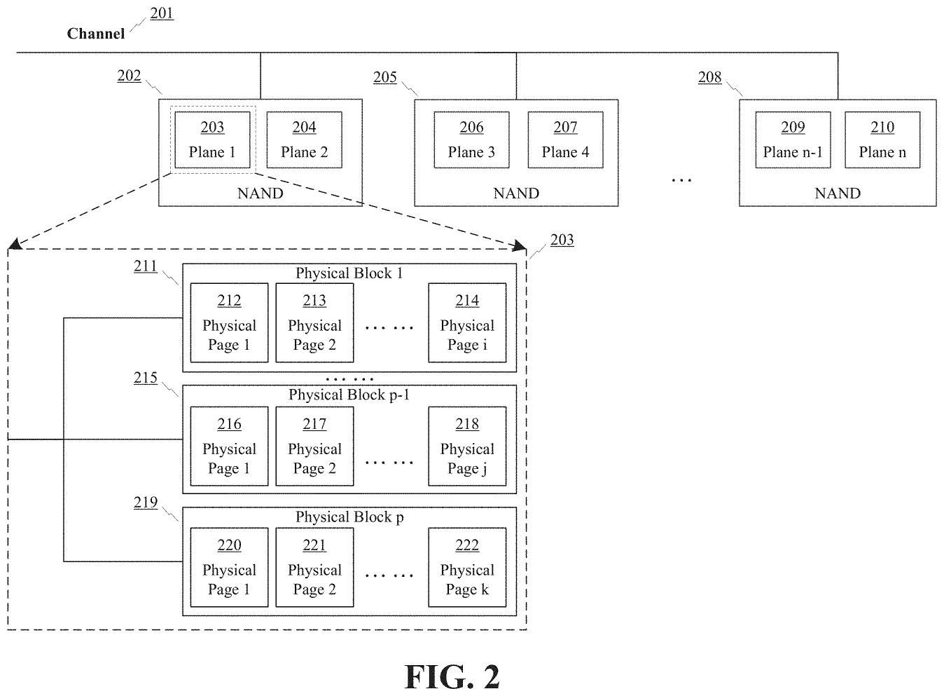

FIG. 2 is an illustration of an exemplary internal NAND flash structure of an SSD, according to some embodiments of the present disclosure. As stated above, a storage controller (e.g., storage controller 104 of FIG. 1) of an SSD is connected with one or more NAND flash integrated circuits (“ICs”), which is where data received by the SSD is ultimately stored. Each NAND IC 202, 205, and 208 typically comprises one or more planes. Using NAND IC 202 as an example, NAND IC 202 comprises planes 203 and 204. As stated above, each plane comprises one or more physical blocks. For example, plane 203 comprises physical blocks 211, 215, and 219. Each physical block comprises one or more physical pages, which, for physical block 211, are physical pages 212, 213, and 214.

An SSD typically stores a single bit in a transistor using the voltage level present (high or ground) to indicate a 0 or 1. Some SSDs also store more than one bit in a transistor using more voltage levels to indicate more values (e.g., 00, 01, 10, and 11 for two bits). Assuming an SSD stores only a single bit for simplicity, an SSD can write a 1 (e.g., can set the voltage of a transistor to high) to a single bit in a page. An SSD cannot write a zero (e.g., cannot set the voltage of a transistor to low) to a single bit in a page. Rather, an SSD can write a zero on a block-level. In other words, to set a bit of a page to zero, an SSD can set every bit of every page within a block to zero. By setting every bit to zero, an SSD can ensure that, to write data to a page, the SSD needs to only write a 1 to the bits as dictated by the data to be written, leaving untouched any bits that are set to zero (since they are zeroed out and thus already set to zero). This process of setting every bit of every page in a block to zero to accomplish the task of setting the bits of a single page to zero is known as garbage collection, since what typically causes a page to have non-zero entries is that the page is storing data that is no longer valid (“garbage data”) and that is to be zeroed out (analogous to garbage being “collected”) so that the page can be re-used.

Further complicating the process of garbage collection, however, is that some of the pages inside a block that are to be zeroed out may be storing valid data—in a worst case, all of the pages inside the block except the page needing to be garbage collected are storing valid data. Since the SSD needs to retain valid data, before any of the pages with valid data can be erased, the SSD (usually through its storage controller) needs to transfer each valid page's data to a new page in a different block. Transferring the data of each valid page in a block is a resource intensive process, as the SSD's storage controller transfers the content of each valid page to a buffer and then transfers content from the buffer into a new page. Only after the process of transferring the data of each valid page is finished may the SSD then zero out the original page (and every other page in the same block). As a result, in general the process of garbage collection involves reading the content of any valid pages in the same block to a buffer, writing the content in the buffer to a new page in a different block, and then zeroing-out every page in the present block.

The impact of garbage collection on an SSD's performance is further compounded by two other limitations imposed by the architecture of SSDs. The first limitation is that only a single page of a block may be read at a time. Only being able to read a single page of a block at a time forces the process of reading and transferring still valid pages to be done sequentially, substantially lengthening the time it takes for garbage collection to finish. The second limitation is that only a single block of a plane may be read at a time. For the entire duration that the SSD is moving these pages—and then zeroing out the block—no other page or block located in the same plane may be accessed.

In some flash drives or flash memories, high-density NAND flash are used with multiple layers stacked together. Also, one cell can store multiple (e.g., 3 or 4) bits. As a result, latency associated with read and write operations on high-density NAND flash drives can become a severe issue for high performance tasks. Moreover, the endurance for the high-density NAND flash drives faces stronger challenge. Furthermore, the high-density NAND builds into the high-capacity SSD. In the range of multiple terabytes (“TBs”), there can be a large amount of data existing in redundancy, which occupies the physical capacity of the flash memory in a sub-optimal manner.

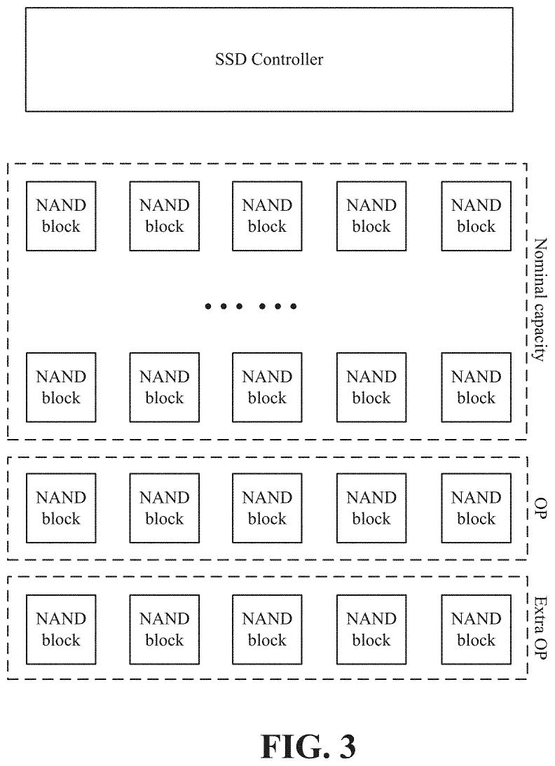

Some solutions attempt to stabilize performance of the flash memory across all fronts. For example, some flash drives try to increase an over-provisioned capacity in each drive. Over-provisioning refers to a difference between the physical capacity of the flash memory and the logical capacity presented as available for a user. During garbage collection, wear-leveling, and bad block mapping operations on the flash drive, the additional space from over-provisioning can help lower the write amplification. FIG. 3 is an illustration of an exemplary flash memory with additional over-provisioning, according to some embodiments of the present disclosure. As shown FIG. 3, the flash memory comprises a plurality of NAND blocks, which are divided into different sections. A first group of the NAND blocks in the flash memory are denoted to the nominal capacity for the flash memory. This is the amount of flash capacity made available to a user. A second group of NAND blocks are denoted to over-provisioning, and a third group of NAND blocks are denoted to extra over-provisioning. The extra over-provisioning can be used for storing data during NAND flash programming and erasing. As a result, the incoming host input/output (“IO”) may not always be affected by the resource utilization of internal operations. It is appreciated that the system may adjust the amount of over-provisioning in the flash drive based on performance requirements

There are a number of issues with the flash memory design shown in FIG. 3. First, the extra over-provisioning leads to a higher cost in resources, since more NAND flash blocks are used in over-provisioning. As a result, the design and operation requirements for the flash memory become higher for an integrated circuit (“IC”) package, thermal design, power consumption, and hardware design. Second, the high-capacity SSD can keep demanding for more over-provisioning to improve performance, but the efficiency of performance gain versus extra over-provisioning partitioning diminishes.

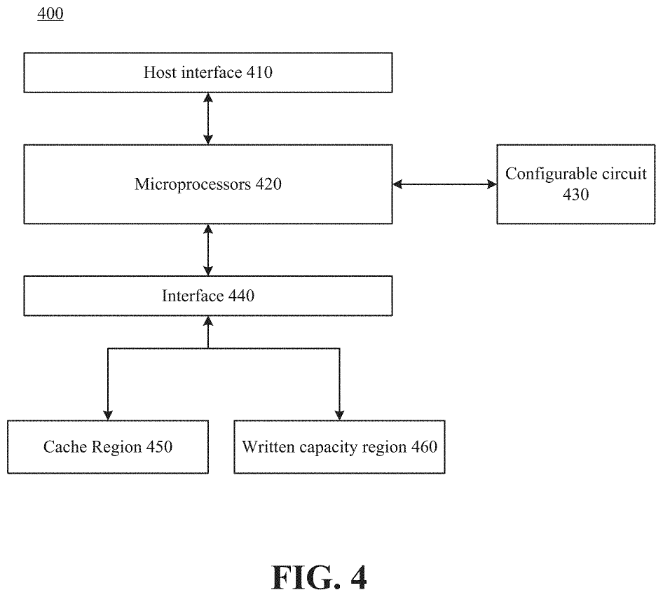

Embodiments of the present disclosure provide an innovative design for memory usage in flash drives or memories to resolve the issues discussed above. FIG. 4 is an illustration of an example flash memory architecture with a cache region, according to some embodiments of the present disclosure. As shown in FIG. 4, flash memory 400 can comprise a host interface 410, one or more microprocessors 420 (e.g., processing units), an interface 440, a cache region 450, or a written capacity region 460. In some embodiments, flash memory 400 comprises a plurality of NAND blocks, which can belong to cache region 450 or written capacity region 460.

In some embodiments, NAND blocks in cache region 450 can be configured as pseudo single-level cell (“pSLC”) to reduce latency in reading and writing operations. pSLC is a multi-level cell (“MLC”) physically but may only store one bit per cell. As a result, pSLC can make a physical MLC operate faster and more durable.

In some embodiments, when a host communicatively coupled to flash memory 400 stores data into flash memory 400, the data can be flushed into cache region 450 first. Since cache region 450 can comprise accelerated cells such as pSLC, the reading and writing operations on the data can be improved, hence enhancing flash memory 400's latency and throughput.

In some embodiments, when data is stored into cache region 450, a number of background operations can take place to clean up the data. For example, a deduplication operation or a compression operation can run in the background to remove data redundancy. A deduplication operation can keep only the unique data and remove redundant duplicate data, while keeping references to the unique data. A compression operation can reduce memory footprint of the data by recoding the data. Later, the processed data can be stored in written capacity region 460. In some embodiments, written capacity region 460 comprises MLC flash, such as triple-level cell (“TLC”) flash or quad-level cells (“QLC”) flash.

In some embodiments, the background processes, including the compression operation and the deduplication operation, can be initiated and operated by microprocessor 420. In some embodiments, microprocessor 420 comprises a hardware acceleration (“HA”). The HA can be an application-specific integrated circuit (“ASIC”) configured for high throughput and low-power, and the HA can be dedicated to run background processes such as the compression operation or the deduplication operation. In some embodiments, microprocessor 420 can balance decompression throughput in high-pressure scenarios and provide design flexibility with reloading the processor for offloading demands.

In some embodiments, flash memory 400 can further comprise a configurable circuit 430. Configurable circuit 430 can be a field programmable gate array (“FPGA”), and configurable circuit 430 can be configured to execute specialized or customized command on flash memory 400's data, including sorting operations. In some embodiments, configurable circuit 430 can be configured to execute background processes such as compression operations or deduplication operations. Together with microprocessor 420, configurable circuit 430 can increase parallelism in operation executions.

In some embodiments, flash memory 400 can be a host-based flash drive. For example, flash memory 400 can be an open-channel SSD. As a result, much of the data organization operations and hardware can be moved to a host. For example, microprocessor 420 and configurable circuit 430 shown in FIG. 4 can be a part of a host that is communicatively coupled to flash memory 400, and the host can perform background processes, including the compression operation and the deduplication operation.

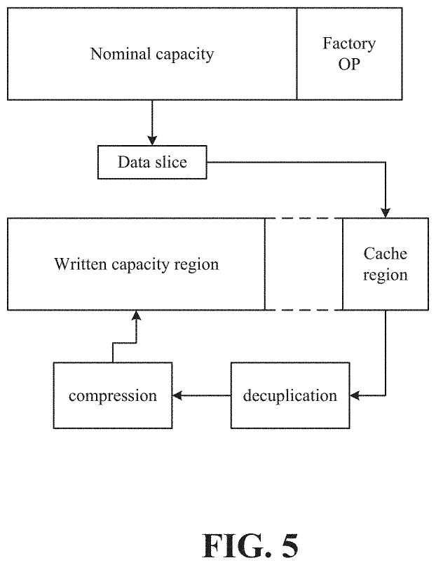

FIG. 5 is an illustration of an example utilization for NAND blocks, according to some embodiments of the present disclosure. As shown in FIG. 5, storage capacities in a flash memory may be initially divided into two parts, namely nominal capacity and factory over-provisioning (OP), similar to the flash memory shown in FIG. 3. In some embodiments, these parts can be programmed to form two other parts, namely a cache region and written capacity region. In some embodiments, the cache region shown in FIG. 5 is similar to cache region 450 shown in FIG. 4, and written capacity region shown in FIG. 5 is similar to written capacity region 460 shown in FIG. 4.

In some embodiments, as shown in FIG. 5, the flash memory may still show the same nominal capacity to users or hosts. When a data slice is stored into the nominal capacity from a user or a host, the data slice is first saved into the cache region. In some embodiments, background processes including the compression operation and the deduplication operation can be conducted on the data slice stored in the cache region. The processed data slice can then be saved into the written capacity, which can be reserved for long-term storage. In some embodiments, because the compression operation and the decompression operation is resource-consuming and critical to the overall performance, deduplication is applied to recognize if the data slice is already stored. Only the unique data slice may be compressed and stored.

In some embodiments, as shown in FIG. 5, the cache region can be a pSLC cache. As a result, similar to cache region 450 shown in FIG. 4, the cache region shown in FIG. 5 may operate a portion of the overall cache capacity, since pSLC may store only 1 bit per cell, as opposed to the physical MLC design that can store multiple bits per cell. As shown in FIG. 5, the cache region occupies a portion of the overall capacity, and there is another portion shown in dotted lines that are reserved for the cache but may not be active. Although the use of pSLC for the cache region may reduce the overall storage capacity, the pSLC can provide reduced latency in reading and writing operations and make the flash cells more durable.

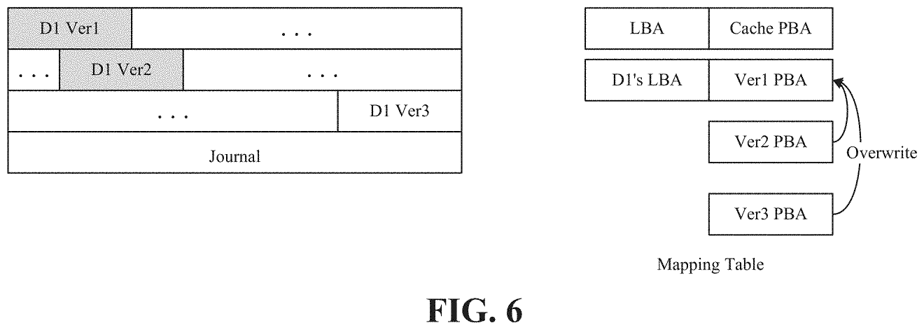

In some embodiments, when a data slice is saved into the cache region, there can be multiple versions of the same data. FIG. 6 is an illustration of an example data organization in flash memories, according to some embodiments of the present disclosure. As shown in FIG. 6, different versions of data can be stored in a journal, which is stored in a cache region (e.g., cache region of FIG. 4 or FIG. 5). There are three versions of data D1, namely ver1, ver2, and ver3. Only the latest version (e.g., ver3) is a valid version for data D1, and the previous versions colored in grey (e.g., ver1 and ver2) are obsolete versions. In some embodiments, the cache region may keep all versions of the data until a next erasing operation. Nonetheless, a logical-to-physical mapping table can be updated in place with the latest version's physical address. For example, in the mapping table shown in FIG. 6, when the first version ver1 for data D1 is stored into the cache region, there is an entry for data D1's logical block addressing (“LBA”). The corresponding physical block addressing (“PBA”) entry stores ver1's PBA. Later, when ver2 is stored, the corresponding PBA entry is overwritten to ver2's PBA. When the latest version ver3 is stored, the corresponding PBA entry can be further updated to ver3's PBA.

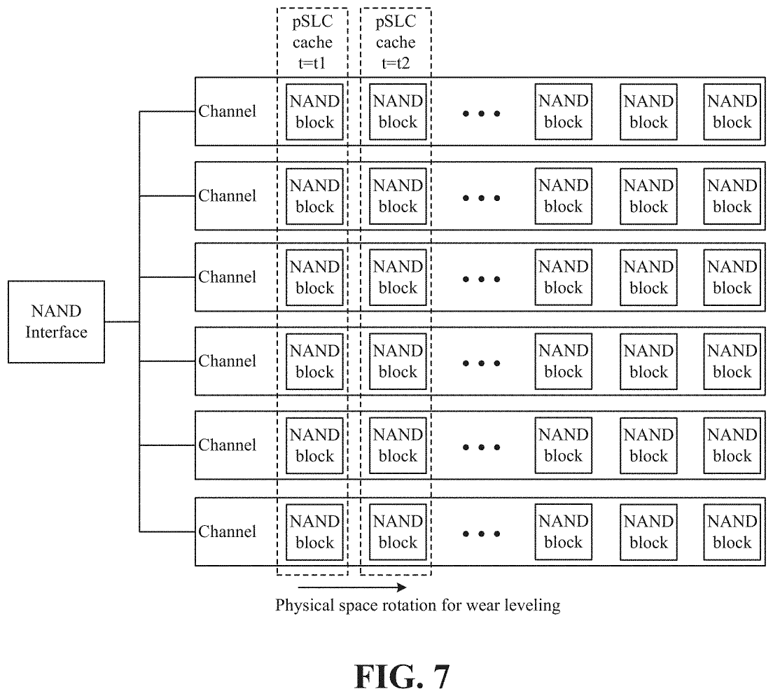

In some embodiments, it is appreciated that the cache region may mainly accommodate intensive write operations and background operations, such as garbage collection (e.g., garbage collection read operations), compression operations, and deduplication operations. As a result, the cache region may be more susceptible to wearing out. To balance the usage within the cache region and between the cache region and the written capacity region, different blocks in the flash memory can be rotated. FIG. 7 is an illustration of an example cache organization for NAND blocks with rotations, according to some embodiments of the present disclosure. It is appreciated that the organization of blocks shown in FIG. 7 can be implemented in flash memories shown in FIG. 4 and FIG. 5.

As shown in FIG. 7, at time moment t1, a plurality of NAND blocks can be used as pSLC for the cache region. In some embodiments, the plurality of NAND blocks comprise a column of NAND blocks across different channels in the flash memory, which can enable parallel reading and writing operations across different channels.

After a certain number of operations (e.g., erasing operations), at time moment t2, the first column of NAND blocks previously reserved for the cache region can be programmed to become a part of the written capacity region. A second column of NAND blocks can be programmed to become a new cache region. As a result, different NAND blocks can be rotated to serve as the cache region for the flash memory, hence increasing the durability for all NAND blocks in the flash memory. In some embodiments, the second column of NAND blocks are NAND blocks recycled from garbage collections.

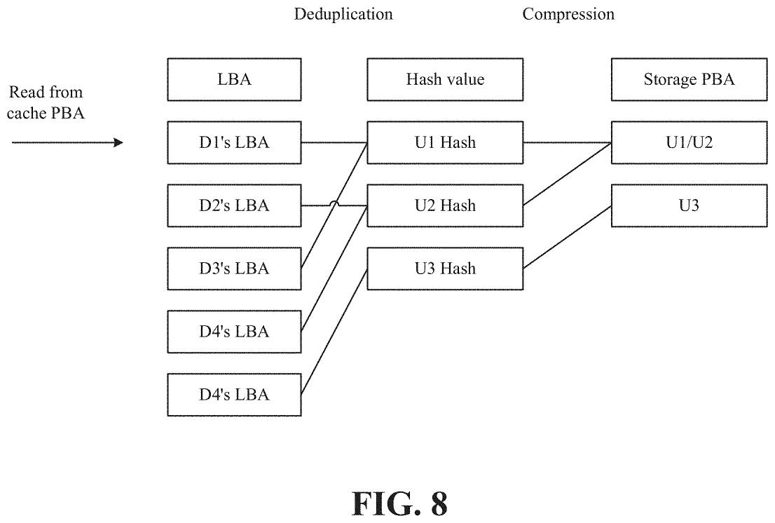

In some embodiments, when data is moved from the cache region to the written capacity region, only valid versions of the data are picked and read to form a large block of data that is sequentially deduplicated and compressed. The large block of data can then be written into the written capacity region. FIG. 8 is an illustration of an example organization of data in a cache region and a written capacity region, according to some embodiments of the present disclosure. It is appreciated that the organization shown in FIG. 8 can be implemented in flash memories shown in FIG. 4 and FIG. 5.

As shown in FIG. 8, when data is read out from the cache region, the data can be deduplicated with non-collision hash values. For example, as shown in FIG. 8, data D1 and D3 may be storing duplicate data. As a result, they point to the same hash value U1. Moreover, there are two different versions of data D4, which may not be duplicative. As a result, the first version of data D4 may point to hash value U2, and the second version of data D4 may point to hash value U3. In some embodiments, if a data slice's hash value matches the hash value library maintained by the flash memory, the data slice's LBA can point to the same hash value.

In some embodiments, as shown in FIG. 8, data pointing to different hash values can be compressed. For example, data pointing to hash values U1 and U2 can be compressed and stored under a same PBA. In some embodiments, it is appreciated that only unique data slice is compressed and stored in the written capacity region. In some embodiments, the mapping table between the hash value and the PBA can denote each unique data slice's physical location for future access.

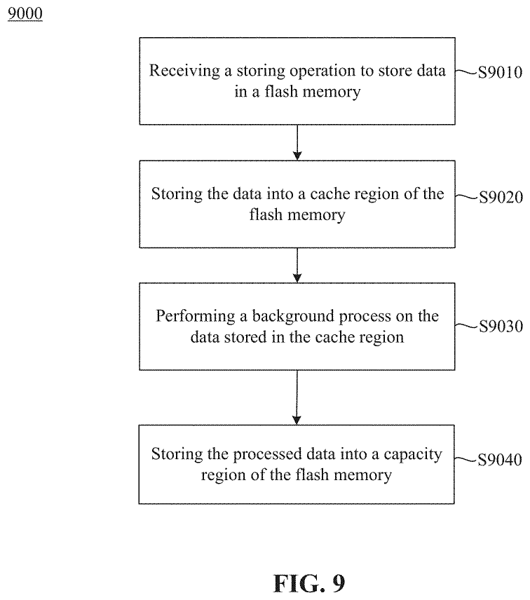

Embodiments of the present disclosure further provide methods for organizing data in flash memories with cache regions. FIG. 9 is an illustration of an example method for managing data in a flash memory with a cache region, according to some embodiments of the present disclosure. It is appreciated that method 9000 of FIG. 9 can be executed on flash memory 400 shown in FIG. 4. For example, the flash memory can be an SSD, and the blocks in the flash memory can be NAND blocks.

In step S9010, a storing operation is received to store data in a flash memory. In some embodiments, the flash memory comprises a plurality of blocks, which can be divided into a cache region and a capacity region. For example, similar to flash memory 400 shown in FIG. 4, flash memory 400 comprises cache region 450 and written capacity region 460. In some embodiments, the flash memory is an SSD, and the plurality of blocks are NAND flash.

In step S9020, the data from step S9010 is stored into a cache region of the flash memory. In some embodiments, the cache region comprises some of the plurality of blocks in the flash memory. In some embodiments, the cache region comprises blocks based in pSLC. For example, similar to the cache region shown in FIG. 4 and FIG. 5, the cache region can comprise pSLC based on MLC. In some embodiments, similar to the flash memory shown in FIG. 7, the cache region comprises blocks across different channels of the flash memory.

In step S9030, a background process is performed on the data stored in the cache region. In some embodiments, the background process can include deduplication operations or compression operations. For example, similar to the data organization shown in FIG. 8, a deduplication process can be performed on the data stored in the cache region to remove duplicative data. In some embodiments, as shown in FIG. 8, the deduplication process can be performed using non-collision hash values. Moreover, a compression process can be performed on the unique data to reduce the memory footprint of the data by recoding the data. In some embodiments, similar to the data organization shown in FIG. 6, the background process can remove obsolete versions of the data. In some embodiments, the background process can be performed by processing units (e.g., microprocessors 420 or configurable circuit 430 of FIG. 4) located in the flash memory or on a host that is communicatively coupled to the flash memory.

In step S9040, the processed data from step S9030 is stored into the capacity region of the flash memory. In some embodiments, the cache region comprises some of the plurality of blocks in the flash memory, and the blocks in the capacity region is different from the blocks in the cache region.

In some embodiments, method 9000 further comprises programming the flash memory to create the cache region and the capacity region. For example, as shown in FIG. 5, a flash memory can comprise the nominal capacity and the over-provisioning. These parts can be programmed to form the cache region and the capacity region. In some embodiments, method 9000 further comprises rotating the blocks in the flash memory between the cache region and the capacity region. For example, as shown in FIG. 7, at different time moments, different columns of NAND blocks from the flash memory can be programmed to become a new cache region, hence increasing the durability for all NAND blocks in the flash memory. In some embodiments, as shown in FIG. 7, the blocks can be assigned from the cache region to the capacity region after a certain number of operations (e.g., read operations, write operations, erasing operations, etc.) performed on the cache region. In some embodiments, the NAND blocks are recycled from garbage collections.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, SSD, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The host system, operating system, file system, and other functional units described in this disclosure can be implemented by hardware, or software, or a combination of hardware and software. One of ordinary skill in the art will also understand that multiple ones of the above described functional units may be combined as one functional unit, and each of the above described functional units may be further divided into a plurality of functional sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

The embodiments may further be described using the following clauses:

1. A method, comprising:

receiving a storing operation to store data in a flash memory, the flash memory comprising a plurality of blocks;

storing the data in a cache region of the flash memory, the cache region comprises a first set of blocks from the plurality of blocks;

processing the data stored in the cache region; and

storing the processed data into a capacity region of the flash memory, the capacity region comprising a second set of blocks from the plurality of blocks that are different from the first set of blocks in the cache region.

2. The method of clause 1, wherein:

the plurality of blocks are multi-level cells, and

the cache region comprises pseudo single-level cells based on the multi-level cells.

3. The method of clause 1 or 2, wherein processing the data stored in the cache region comprises:

performing a deduplication operation to remove duplicates in the data, and

performing a compression operation to compress data remaining after the deduplication operation.

4. The method of clause 3, wherein performing the deduplication operation comprises:

deduplicating data using non-collision hash values.

5. The method of any one of clauses 1-4, wherein processing the data stored in the cache region comprises:

removing obsolete versions of the data.

6. The method of any one of clauses 1-5, further comprising:

rotating the plurality of blocks between the cache region and the capacity region.

7. The method of clause 6, wherein rotating the plurality of blocks between the cache region and the capacity region comprises:

in response to a number of erasing operations performed on the cache region:
assigning first set of blocks from the cache region to the capacity region, and
assigning at least some of the second set of blocks from the capacity region to the cache region.

8. The method of any one of clauses 1-7, wherein the first set of blocks in the cache region belong to different channels of the flash memory.

9. The method of any one of clauses 1-8, wherein:

the flash memory is a solid-state drive, and

the plurality of blocks are NAND flash.

10. A system, comprising:

a flash memory configured to store data based on a storing operation, the flash memory comprising:
a cache region comprising a first set of blocks and configured to store the data in response to the flash memory receiving the storing operation, wherein the data stored in the cache region is processed, and
a capacity region comprising a second set of blocks and configured to store the processed data from the cache region.

11. The system of clause 10, wherein the processing unit is a part of the flash memory.

12. The system of clause 10 or 11, wherein:

the first set of blocks are pseudo single-level cells, and

the second set of blocks are multi-level cells.

13. The system of any one of clauses 10-12, wherein:

a deduplication operation is performed on the data stored in the cache region to remove duplicates in the data, and

a compression operation is performed on the data remaining after the deduplication operation to compress the data.

14. The system of clause 13, wherein the deduplication operation removes duplicates in the data using non-collision hash values.

15. The system of any one of clauses 10-14, wherein the data stored in the cache region is processed to remove obsolete versions of the data.

16. The system of any one of clauses 10-15, wherein:

at least some blocks in the first set of blocks and the second set of blocks are rotated between the cache region and the capacity region.

17. The system of clause 16, wherein:

in response to a number of erasing operations performed on the cache region:
the first set of blocks from the cache region are assigned to the capacity region in response to a number of erasing operations performed on the cache region, and
at least some of the second set of blocks from the capacity region are assigned to the cache region.

18. The system of any one of clauses 10-17, wherein the first set of blocks in the cache region belong to different channels of the flash memory.

19. The system of any one of clauses 10-18, wherein:

the flash memory is a solid-state drive, and the first set of blocks and the second set of blocks are NAND flash.

20. A non-transitory computer readable medium that stores a set of instructions that is executable by at least one processor of a computer system to cause the computer system to perform a method, the method comprising:

receiving a storing operation to store data in a flash memory, the flash memory comprising a plurality of blocks;

storing the data in a cache region of the flash memory, the cache region comprises a first set of blocks from the plurality of blocks;

processing the data stored in the cache region; and

storing the processed data into a capacity region of the flash memory, the capacity region comprising a second set of blocks from the plurality of blocks that are different from the first set of blocks in the cache region.

21. The non-transitory computer readable medium of clause 20, wherein:

the plurality of blocks are multi-level cells, and

the cache region comprises pseudo single-level cells based on the multi-level cells.

22. The non-transitory computer readable medium of clause 20 or 21, wherein the set of instructions is executable by the at least one processor of the computer system to cause the computer system to further perform:

a deduplication operation to remove duplicates in the data, and

a compression operation to compress data remaining after the deduplication operation.

23. The non-transitory computer readable medium of clause 22, wherein the set of instructions is executable by the at least one processor of the computer system to cause the computer system to further perform:

deduplicating data using non-collision hash values.

24. The non-transitory computer readable medium of any one of clauses 20-23, wherein the set of instructions is executable by the at least one processor of the computer system to cause the computer system to further perform:

removing obsolete versions of the data.

25. The non-transitory computer readable medium of any one of clauses 20-24, wherein the set of instructions is executable by the at least one processor of the computer system to cause the computer system to further perform:

rotating the plurality of blocks between the cache region and the capacity region.

26. The non-transitory computer readable medium of clause 25, wherein the set of instructions is executable by the at least one processor of the computer system to cause the computer system to further perform:

in response to a number of erasing operations performed on the cache region:
assigning first set of blocks from the cache region to the capacity region, and
assigning at least some of the second set of blocks from the capacity region to the cache region.

27. The non-transitory computer readable medium of any one of clauses 20-26, wherein the first set of blocks in the cache region belong to different channels of the flash memory.

28. The non-transitory computer readable medium of any one of clauses 20-27, wherein:

the flash memory is a solid-state drive, and

the plurality of blocks are NAND flash. In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method, comprising:
receiving a storing operation to store data in a flash memory, the flash memory comprising a plurality of blocks;
storing the data in a cache region of the flash memory, the cache region comprises a first set of blocks from the plurality of blocks;
processing the data stored in the cache region; and
storing the processed data into a capacity region of the flash memory, the capacity region comprising a second set of blocks from the plurality of blocks that are different from the first set of blocks in the cache region.

2. The method of claim 1, wherein:
the plurality of blocks are multi-level cells, and
the cache region comprises pseudo single-level cells based on the multi-level cells.

3. The method of claim 1, wherein processing the data stored in the cache region comprises:
performing a deduplication operation to remove duplicates in the data, and
performing a compression operation to compress data remaining after the deduplication operation.

4. The method of claim 3, wherein performing the deduplication operation comprises:
deduplicating data using non-collision hash values.

5. The method of claim 1, wherein processing the data stored in the cache region comprises:
removing obsolete versions of the data.

6. The method of claim 1, further comprising:
rotating the plurality of blocks between the cache region and the capacity region.

7. The method of claim 6, wherein rotating the plurality of blocks between the cache region and the capacity region comprises:
in response to a number of erasing operations performed on the cache region:
assigning first set of blocks from the cache region to the capacity region, and
assigning at least some of the second set of blocks from the capacity region to the cache region.

8. The method of claim 1, wherein the first set of blocks in the cache region belong to different channels of the flash memory.

9. The method of claim 1, wherein:
the flash memory is a solid-state drive, and
the plurality of blocks are NAND flash.

10. A system, comprising:
a flash memory configured to store data based on a storing operation, the flash memory comprising:
a cache region comprising a first set of blocks and configured to store the data in response to the flash memory receiving the storing operation, wherein the data stored in the cache region is processed, and
a capacity region comprising a second set of blocks and configured to store the processed data from the cache region.

11. The system of claim 10, wherein the processing unit is a part of the flash memory.

12. The system of claim 10, wherein:
the first set of blocks are pseudo single-level cells, and
the second set of blocks are multi-level cells.

13. The system of claim 10, wherein:
a deduplication operation is performed on the data stored in the cache region to remove duplicates in the data, and
a compression operation is performed on the data remaining after the deduplication operation to compress the data.

14. The system of claim 13, wherein the deduplication operation removes duplicates in the data using non-collision hash values.

15. The system of claim 10, wherein the data stored in the cache region is processed to remove obsolete versions of the data.

16. The system of claim 10, wherein:
at least some blocks in the first set of blocks and the second set of blocks are rotated between the cache region and the capacity region.

17. The system of claim 16, wherein:
in response to a number of erasing operations performed on the cache region:
the first set of blocks from the cache region are assigned to the capacity region in response to a number of erasing operations performed on the cache region, and
at least some of the second set of blocks from the capacity region are assigned to the cache region.

18. The system of claim 10, wherein the first set of blocks in the cache region belong to different channels of the flash memory.

19. The system of claim 10, wherein:
the flash memory is a solid-state drive, and
the first set of blocks and the second set of blocks are NAND flash.

20. A non-transitory computer readable medium that stores a set of instructions that is executable by at least one processor of a computer system to cause the computer system to perform a method, the method comprising:
receiving a storing operation to store data in a flash memory, the flash memory comprising a plurality of blocks;
storing the data in a cache region of the flash memory, the cache region comprises a first set of blocks from the plurality of blocks;
processing the data stored in the cache region; and
storing the processed data into a capacity region of the flash memory, the capacity region comprising a second set of blocks from the plurality of blocks that are different from the first set of blocks in the cache region.
